(19) United States
(12) Patent Application Publication
(10) Pub. No.: US 2018/0120848 A1
(43) Pub. Date: May 3, 2018

(54) GEOTAGGING THROUGH PRIMARY VEHICLE CONTROLS

(71) Applicant: MOJ.IO INC., VANCOUVER (CA)

(72) Inventor: JAMES KULFERST, VANCOUVER (CA)

(73) Assignee: MOJ.IO INC., VANCOUVER (CA)

(21) Appl. No.: 15/336,297

(22) Filed: Oct. 27, 2016

(51) Int. Cl. G05D 1/02; G06F 17/30; G06N 99/00; G01C 21/36; G05D 1/00

(52) U.S. Cl. CPC G05D 1/021; G06F 17/30241; G05D 1/0022; G01C 21/367; G01C 21/362; G06N 99/005

(57) ABSTRACT

A geotagging method performed by a computing system that includes at least one computing device residing on-board a human-operable vehicle is disclosed. In an example, sensor data indicating a time-based series of actuation events performed by a human operator of the vehicle is received for one or more primary vehicle control interfaces of the vehicle, such as a steering control interface, an accelerator control sensor, and a brake control sensor. The computing system identifies a pre-defined set of actuation events from among the time-based series of actuation events. A target geo-location of the vehicle is identified from among a time-based series of geo-locations that is proximate in-time to the pre-defined set of actuation events. The target geo-location is associated with a data indicator that attributes performance of the pre-defined set of actuation events by the human operator to a geotagging input by the human operator for the target geo-location.

### BACKGROUND

Human-operable vehicles typically include one or more primary vehicle control interfaces for steering, acceleration, and braking/deceleration of the vehicle. Control interfaces for steering may include a steering wheel or a handlebar, for example. Control interfaces for acceleration or braking/deceleration may include a foot pedal, hand lever or other suitable interface device. Automated self-driving vehicles may also incorporate one or more of these primary vehicle control interfaces to enable human passengers to correct errors or respond to emergency conditions while the vehicle is operated in a self-driving mode of operation.

Modern vehicles typically include on-board electronic control/monitoring systems that manage, measure, and report operation of the vehicle's various subsystems. On-board electronic control/monitoring systems may include or otherwise support on-board diagnostic (OBD) services that enable vehicle owners and repair technicians to access diagnostic information or other forms of operational information from the vehicle. For example, on-board electronic control/monitoring systems of a vehicle may be accessed via a data interface in the form of a physical wired data link connector or data port. OBD information may be communicated over this data interface using a variety of protocols, including ALDL, OBD-I, OBD-1.5, OBD-II, etc., to name a few examples.

### BRIEF DESCRIPTION OF DRAWINGS

FIG. 1 is a schematic diagram depicting an example interaction between system components located both on-board a vehicle and off-board the vehicle.

FIG. 2 is a flow diagram depicting an example geotagging method.

FIG. 3 is a schematic diagram depicting an example graph that provides a visual comparison between time and other parameters relating to vehicle operation.

FIG. 4 is a schematic diagram depicting a system that may serve as a non-limiting example of an implementation of the system of FIG. 1.

FIG. 5 is a schematic diagram depicting an example computing system.

### DETAILED DESCRIPTION

Geotagging refers to a process by which geo-location information corresponding to a physical position on earth is associated with another set of information. Within the context of the present disclosure, geotagging may be performed in response to a human operator of a vehicle interacting with one or more primary vehicle control interfaces of the vehicle to perform a set of pre-defined actuation events. Primary vehicle control interfaces include steering, acceleration, or braking/deceleration control interfaces that are commonplace on all or most human operable vehicles. In at least some implementations, these pre-defined actuation events may be defined to be distinguishable from actuation events that are associated with typical driving behavior to thereby enable the human operator of the vehicle to intentionally create geotags at any suitable geo-location along the vehicle's path of travel. As a non-limiting example, the vehicle operator may pump an acceleration control interface (e.g., a foot pedal) multiple times within a particular time period to create a geotag at the current geo-location of the vehicle. Various other examples are described herein for initiating a geotagging process.

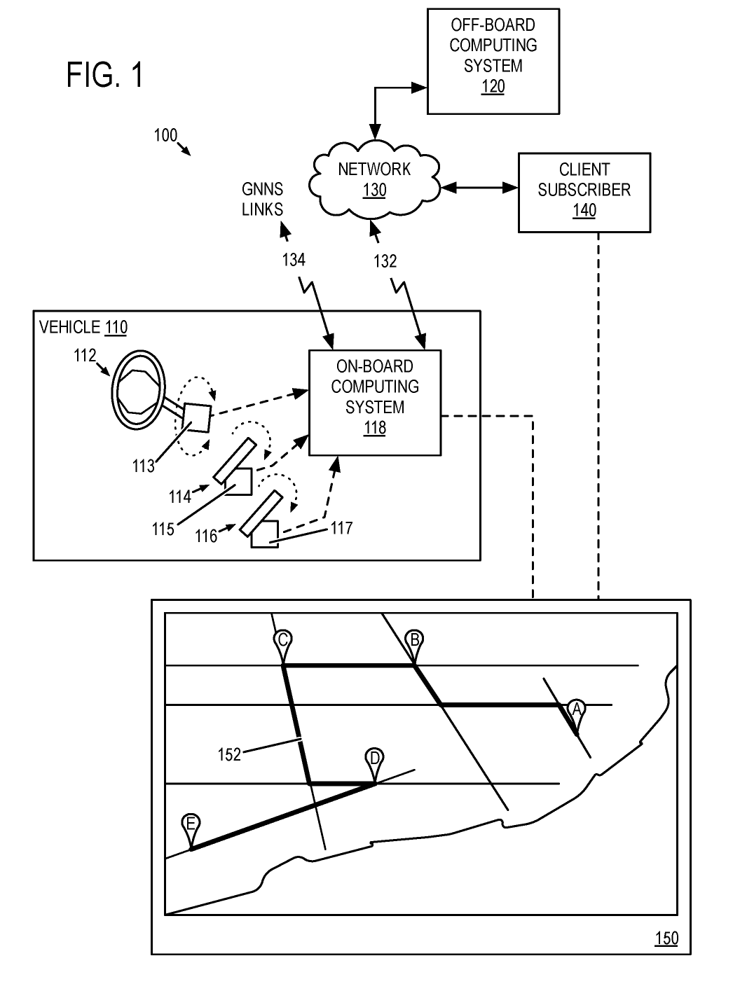

FIG. 1 is a schematic diagram depicting an example interaction between components of system 100 located both on-board a vehicle 110 and off-board the vehicle. Vehicle 110 refers to a human-operable vehicle and may take various forms. For example, vehicle 110 may correspond to a street-legal passenger vehicle such as a car, truck, bus, motorcycle, etc., to name just a few examples. However, vehicle 110 may take other suitable forms.

Vehicle 110 includes one or more primary vehicle control interfaces for steering, acceleration, and braking/deceleration of the vehicle. Control interfaces for steering may include a steering wheel or a handlebar, for example. Control interfaces for acceleration or braking/deceleration may include a foot pedal, hand lever or other suitable interface device. For example, vehicle 110 includes a steering control interface 112 that includes a steering wheel, an acceleration control interface 114 that includes a first foot pedal, and a braking/deceleration control interface 116 that includes a second foot pedal. Automated self-driving vehicles may also incorporate one or more of these primary vehicle control interfaces to enable human passengers to correct errors or respond to emergency conditions while the vehicle is operated in a self-driving mode of operation.

Each of the above described primary vehicle control interfaces may include or may be associated with one or more sensors located on-board the vehicle that measure actuation of that respective primary vehicle control interface. Measurements obtained by such sensors may measure a magnitude and/or a direction of actuation of a primary vehicle control interface. Additionally or alternatively, such sensors may provide a measurement in the form of an indication (e.g., a binary indication) of whether a primary vehicle control interface is actuated or not actuated by the vehicle operator. For example, a first sensor may provide a measurement of pedal position of the first foot pedal of acceleration control interface 114 and/or may provide an indication of whether acceleration control interface 114 is actuated by the vehicle operator. A second sensor may provide measurement of pedal position of the second foot pedal of braking/deceleration control interface 116 and/or may provide an indication of whether braking/deceleration control interface 116 is actuated by the vehicle operator. Measurements obtained via these first and second sensors may be received by the electronic control/monitoring system of the vehicle, and may be used to provide a corresponding output from the electronic control/monitoring system in the form acceleration or braking/deceleration control signals, in at least some examples.

Typically, acceleration and braking/deceleration control interfaces have a single degree of freedom in which the vehicle operator actuates the control interface by depressing the control interface by a desired degree. These control interfaces may be configured to return to a reference or zeroed position upon release of the control interface by the vehicle operator. Interaction with these control interfaces may be measured or otherwise identified as a magnitude of actuation or a binary determination of actuated/not-actuated states. By contrast, control interfaces for steering typically have two degrees of freedom to provide left and right steering of the vehicle. These control interfaces may be measured and reported as a magnitude (and/or a binary determination of actuated/not-actuated states) and additionally as a direction (e.g., left and right directions) relative to a reference, such as a dead-center position of the vehicle's steering.

In some implementations, one or more of these primary control interfaces may not include or may not be associated with a dedicated sensor for directly measuring actuation by the vehicle operator. In these implementations, other suitable sensors located on-board the vehicle may provide a measurement of whether a primary vehicle control interface was actuated by the vehicle operator, a magnitude of actuation, and/or a direction of actuation.

In the case of a braking/deceleration control interface, actuation of this control interface by the vehicle operator may be identified, measured, or otherwise inferred from sensor measurements obtained via a brake fluid pressure sensor, a vehicle speed sensor, an electric motor speed sensor or a sensor that measures electrical energy generated by the electric motor (e.g., in the case of regenerative braking), an accelerometer/inertial sensor, or other suitable sensor located on-board the vehicle, to name just a few examples. In these examples, actuation of the braking/deceleration control interface may be at least inferred from a threshold increase or rate thereof in brake fluid pressure, a threshold decrease or rate thereof in vehicle speed, a threshold increase or rate thereof in electric motor speed or electrical energy generation (e.g., in the case of regenerative braking), or a threshold deceleration or rate thereof in accelerometer/inertial sensor measurements along an axis that is parallel to the forward path of travel direction of the vehicle.

In the case of a steering control interface, actuation of this control interface by the vehicle operator may be identified, measured, or otherwise inferred from sensor measurements obtained via a sensor associated with power-steering subsystems, such as a power-steering fluid pressure sensor, a sensor that measures an energy consumption or speed of a motor or pump associated with the power-steering subsystem, an accelerometer/inertial sensor, or other suitable sensor located on-board the vehicle. In these examples, actuation of the steering control interface may be at least inferred from a threshold increase or rate thereof in power-steering fluid pressure, power-steering motor or pump speed or energy consumption, or a threshold acceleration or rate thereof in accelerometer/inertial sensor measurements in a lateral direction of the vehicle.

In the case of an acceleration control interface, actuation of this control interface may be identified, measured, or otherwise inferred from sensor measurements obtained via a fuel consumption rate sensor, an engine or drive motor speed sensor, electrical energy consumption sensor for energy consumed by a drive motor, a vehicle speed sensor, an accelerometer/inertial sensor, or other suitable sensor located-board the vehicle. In these examples, actuation of the acceleration control interface may be at least inferred from a threshold increase or rate thereof in fuel consumption rate, engine or motor speed, electrical energy consumption by the drive motor, the vehicle speed, or a threshold acceleration or rate thereof in accelerometer/inertial sensor measurements along an axis that is parallel to the forward path of travel direction of the vehicle.

In view of the above example sensor implementations, a sensor by which actuation of steering control interface 112 may be measured is represented schematically at 113, a sensor by which actuation of acceleration control interface 114 may be measured is represented schematically at 115, and a sensor by which actuation of braking/deceleration control interface 116 may be measured is represented schematically at 117. As a non-limiting example, sensors 115 and 117 may correspond to pedal position sensors, as are commonly present in consumer available vehicles. Sensor 113 may also take the form of sensors that are commonly present in consumer available vehicles. Sensors 113, 115, 117 may take the form of potentiometers or hall effect sensors to provide additional non-limiting examples. However, other suitable sensors may be used. Sensors 113, 115, and 117 output and provide sensor measurements in the form of sensor data to an on-board computing system 118 that resides on-board vehicle 110. While sensors 113, 115, and 117 are depicted as separate sensors, in at least some implementations, the same sensor or the same set of two or more sensors (e.g., an accelerometer/inertial sensor) may be used to detect, infer, or otherwise measure actuation of two or more primary control interfaces of the vehicle. Accordingly, sensors 113, 115, and 117 may correspond to the same sensor in these implementations.

On-board computing system 118 receives, processes, stores, and/or transmits sensor data receives from on-board sensors (including sensors 113, 115, and 117) in raw and/or processed form to one or more of: (1) off-board computing devices or systems, such as off-board computing system 120 and/or client subscriber 140, for example, and/or (2) between on-board computing devices of the on-board computing system (e.g., over a wired or wireless communications link). As indicated schematically at 134, on-board computing system 118 may include a geo-location sensor subsystem that receives global navigation satellite system (GNSS) downlink signals (e.g., geo-location data) and/or otherwise communicates with geo-positioning satellites, terrestrial wireless base stations, etc. to determine a geo-location of the vehicle (e.g., GPS longitude and latitude coordinates) at a particular instance in time. Geo-location data representing a time-series of geo-locations of the vehicle may be periodically or constantly measured, stored, and/or transmitted by the on-board computing system to other computing devices, at least during operation of the vehicle.

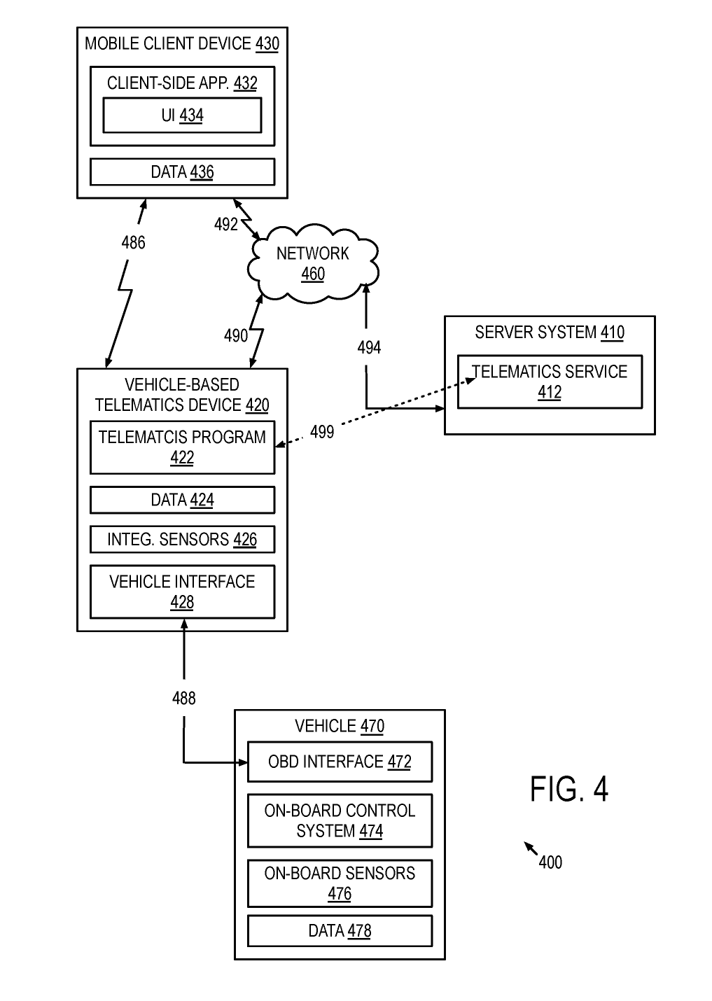

On-board computing system 118 includes one or more computing devices. One or more computing devices of on-board computing system 118 may be integrated with the on-board electronic control/monitoring system of the vehicle. Alternatively or additionally, one or more computing devices of on-board computing system 118 may take the form of a separate, independent, or aftermarket computing device or a personal computing device carried by a human operator or passenger of the vehicle that interfaces with the on-board electronic control/monitoring system of the vehicle via a wired or wireless communications link. A non-limiting example of an on-board computing system is described in further detail with reference to FIG. 4.

System 100 may include one or more off-board computing devices, such as off-board computing system 120 and/or client devices (e.g., client subscriber 140). Off-board computing system 120 may include one or more server devices, and may form a server system. For example, off-board computing system may host a telematics service and may be operated by a telematics service provider that receives telematics data reported by on-board computing system 118 over a communications network 130. Communications network 130 may include a wide area network (WAN), such as the Internet, and may include wireless network components by which on-board computing system 118 transmits or receives wireless communications, as indicated schematically at 132. Within the context of a telematics service, off-board computing system 120 may communicate with on-board computing systems of a fleet of many vehicles that include vehicle 110. Each vehicle and/or on-board computing system or device may be identified by a respective identifier that enables the telematics service to distinguish vehicles or computing devices from each other, and identify the source/destination of data or communications.

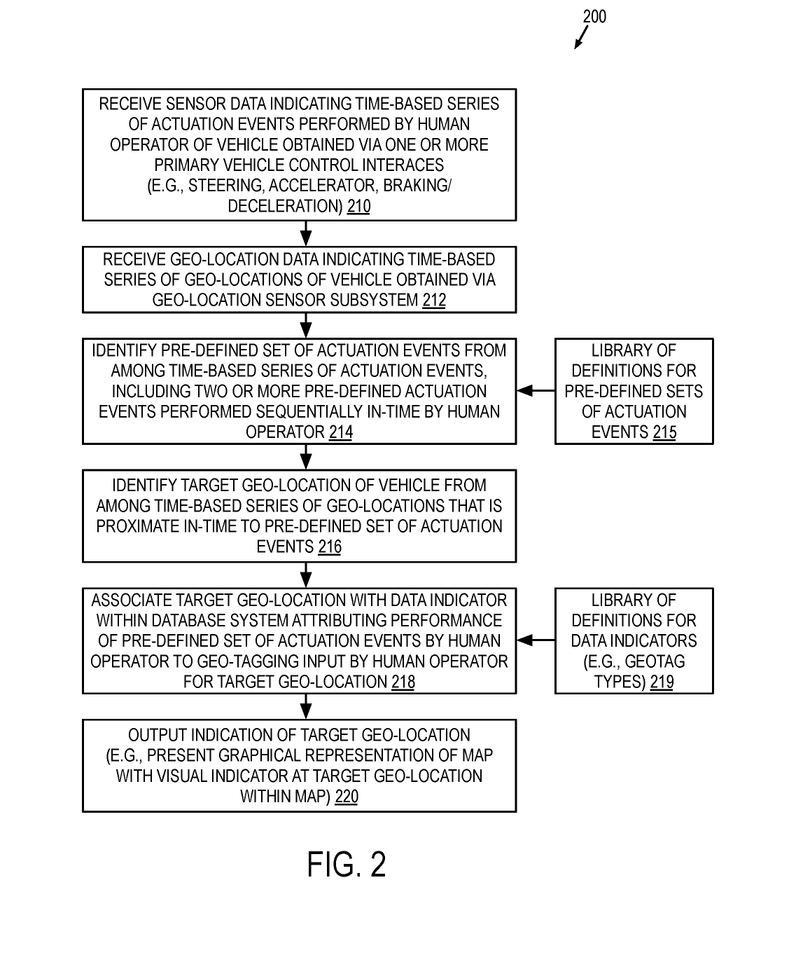

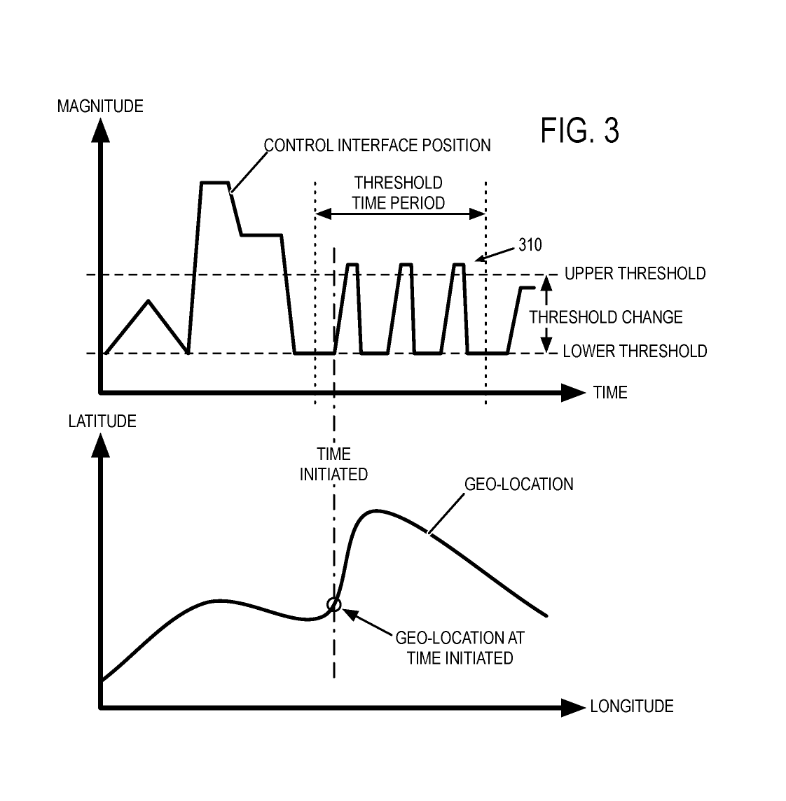

A computing device associated with on-board computing system 118 or client subscriber 140 may present a graphical representation of a map via a display device with one or more visual indicators that depict a path of travel of the vehicle and/or one or more identifiers representing geotagged locations along the path of travel of the vehicle. The path of travel and geotagged locations may be obtained based, at least in part, on geo-location data obtained from the geo-location subsystem of on-board computing system 118, in at least some implementations. An example graphical representation of a map 150 is depicted in FIG. 1 in which five example geotagged locations are indicated respectively by pins A-E along an example path of travel 152 for vehicle 110. Pins A-E provide non-limiting examples of visual indicators that may be presented to end users via a graphical user interface. It will be understood that other suitable indicators may be used to convey information regarding a geo-tagged location. As will be described in further detail with reference to FIGS. 2 and 3, a human operator of a vehicle, such as example vehicle 110, may operate one or more primary vehicle control interfaces 112, 114, 116 in a specific manner to initiate a geotagging operation for a particular geo-location (e.g., the current geo-location) of the vehicle.

FIG. 2 is a flow diagram depicting an example geotagging method 200. In an example, method 200 or portions thereof may be performed by a computing system that includes at least one computing device residing on-board a human-operable vehicle. The computing system may include one or more on-board computing devices and/or one or more off-board computing devices. FIG. 1 provides a non-limiting example of a computing system that includes at least one computing device located on-board a human operable vehicle. This on-board computing device may interface with an electronic control/monitoring system of the vehicle via an OBD-compliant data link, in at least some implementations. As another example, this on-board computing device may be integrated with the electronic control/monitoring system of the vehicle. As will be described in further detail with reference to method 200, a human operator of the vehicle may use some or all of these primary vehicle control interfaces to provide a geotagging input to the computing system that initiates a geotagging process on-behalf of the human operator.

At 210, the method includes receiving, at the computing device of the computing system, sensor data indicating a time-based series of actuation events performed by a human operator of the vehicle and obtained via one or more primary vehicle control interfaces of the vehicle by way of one or more on-board sensors. As previously described with reference to FIG. 1, in an example for a typical road vehicle, the primary vehicle control interfaces include a steering control interface (e.g., a steering wheel), an acceleration control interface (e.g., an accelerator pedal), and a braking/deceleration control interface (e.g., a braking/deceleration pedal). As a sub-process to operation 210, the computing device may store the sensor data, in raw or processed forms, in a database system from which the sensor data may be later referenced and/or may transmit the sensor data, in raw or processed forms, to another computing device of the computing system (e.g., residing either on-board or off-board).

The sensor data received at 210 may originate from one or more sensors located on-board the vehicle. Such sensors may be integrated with the vehicle or may be located on-board computing devices that are not necessarily integrated with or are separate from the vehicle, such as aftermarket computing devices or personal computing devices carried by the vehicle operator or passengers located on-board the vehicle (e.g., accelerometer/inertial sensors of such devices). Non-limiting examples of such sensors were previously described with reference to sensors 113, 115, and 117 of FIG. 1. As also previously described with reference to FIG. 1. the computing device residing on-board the vehicle may take various forms, including a computing device that is integrated into the electronic control/monitoring system of the vehicle, an aftermarket computing device that interfaces with the electronic control/monitoring system of the vehicle via a wired or wireless data link, a handheld personal computer device of a vehicle operator or passenger of the vehicle, etc. to name a few examples. The computing system, which includes the computing device residing on-board the vehicle, may further include one or more additional computing devices located on-board or off-board the vehicle. For example, an on-board computing system may include a first on-board computing device integrated with the electronic control/monitoring system of the vehicle and a second on-board computing device that communicates with the first computing device via a wired or wireless communications link over a personal area network or local area network. Additional aspects of these various hardware implementations are described in further detail with reference to FIG. 4.

At 212, the method includes receiving geo-location data indicating a time-based series of geo-locations of the vehicle obtained via a geo-location sensor subsystem of the computing system. This time-based series of geo-locations may utilize any suitable time-based resolution, and may be implementation-dependent to account for factors such as vehicle speed, vehicle type, data accuracy, etc. Each geo-location represented by the geo-location data may include or may be associated with a corresponding time value that represents a time at which the vehicle was present at that geo-location. In at least some implementations, the geo-location sensor subsystem is located on-board the vehicle, and is configured to receive GNSS signals from satellites and/or terrestrial base stations, compute a geo-location of the vehicle based on the GNSS signals, and output an indication of the geo-location of the vehicle as geo-location data. For example, the geo-location sensor subsystem may output the indication of the geo-location of the vehicle as geo-location data that includes a time-based series of GPS longitude and latitude coordinates that collectively define a path of travel of the vehicle. However, other suitable geo-location formats may be used. This geo-location sensor subsystem may form part of the computing device that receives sensor data at 210 or may form part another on-board computing device or component. As a sub-process to operation 212, a computing device of the computing system may store the geo-location data, in raw or processed forms, in a database system from which the geo-location data may be later referenced and/or may transmit the geo-location data, in raw or processed forms, to another computing device of the computing system (e.g., either on-board or off-board).

At 214, the method includes identifying a pre-defined set of actuation events from among the time-based series of actuation events received at 210. The pre-defined set of actuation events may include two or more pre-defined actuation events performed sequentially in-time by the human operator within the time-based series of actuation events. In at least some implementations, the computing system or a computing device thereof may reference a database system that contains a library of definitions for one or more pre-defined sets of actuation events, as indicated at 215. These definitions for pre-defined sets of actuation events may be stored in a database system within a computer-readable data storage device that is located on-board the vehicle and/or off-board the vehicle, depending on implementation. A pre-defined set of actuation events may be user-defined in at least some implementations, or may be pre-defined by the telematics service provider within this library of definitions. For user-defined implementations, the user may select from a list of pre-defined sets of actuation events previously established by the telematics service provider or may provide a user input to define new combinations of actuation events that form a pre-defined set of actuation events. Such user input may take the form of a training phase in which the user input includes a human operator of a vehicle actuating one or more of primary vehicle control interfaces, which are recorded by the on-board computing device or the computing system. Alternatively, such user input may take the form of data supplied by the user to menus or data fields within a graphical user interface that communicates with the computing system.

As a sub-process to operation 214, the computing system may identify a time value that corresponds to a time that the identified pre-defined set of actuation events was performed by the vehicle operator. In at least some implementations, this time value may correspond to a timing of the first actuation event of the pre-defined set of actuation events. However, other suitable timings may be used for the time value, such as an average time value across the pre-defined set of actuation events or a time value preceding the performance of the first actuation event for which a geo-location measurement is available to the computing system. The time value identified above may be stored in a database system and/or transmitted to another computing device of the computing system.

As another sub-process to operation 214, the computing system may identify or otherwise measure one or more attributes of the sensor data obtained at 210, including the various actuation events thereof. For example, the computing system may identify, for each primary vehicle control interface, whether an actuation has occurred, a timing of that actuation, a magnitude of that actuation, a direction of that actuation, a rate of change of that actuation, etc. In at least some implementations, the computing system may continuously monitor for the presence of actuation events within the sensor data obtained at 210, and compare those actuation events to the definitions for some or all of the pre-defined sets of actuation events that are presently active or enabled to determine whether a pre-defined set of actuation events is present within the sensor data.

As a first example, a definition for a pre-defined set of actuation events may specify that each actuation event of the pre-defined set of actuation events exceeds at least a threshold magnitude or at least a threshold change in magnitude for each actuation event, and additionally, in at least some implementations, that each actuation event of the pre-defined set of actuation events is performed sequentially in-time within a pre-defined time period.

As a second example, a definition for a pre-defined set of actuation events may specify that each actuation event of the pre-defined set of actuation events includes a dynamic change in a direction and/or a magnitude for each actuation event from a reference point, and additionally, in at least some implementations, that each actuation event of the pre-defined set of actuation events is performed sequentially in-time within a pre-defined time period.

As a third example, a definition for a pre-defined set of actuation events may specify that each actuation event of the pre-defined set of actuation events includes a release and re-engagement of a primary vehicle control interface for each actuation event, and additionally, in at least some implementations, that each actuation event of the pre-defined set of actuation events is performed sequentially in-time within a pre-defined time period.

As a fourth example, a definition for a pre-defined set of actuation events may specify that the pre-defined set of actuation events for a particular primary vehicle control interface includes at least two actuation events (e.g., indicated at least through binary sensing of actuation) performed sequentially in-time within a pre-defined time period via that primary vehicle control interface.

As a fifth example, a definition for a pre-defined set of actuation events may specify that the pre-defined set of actuation events for a particular primary vehicle control interface includes at least three actuation events (e.g., indicated at least through binary sensing of actuation) performed sequentially in-time within a pre-defined time period via that primary vehicle control interface.

As a sixth example, a definition for a pre-defined set of actuation events may specify that the pre-defined set of actuation events for two or more particular primary vehicle control interfaces includes at least two or more actuation events performed sequentially in-time within a pre-defined time period via those two or more primary vehicle control interfaces and in a particular order with respect to those two or more primary vehicle control interfaces.

Some or all of the above examples or definition parameters thereof may be combined (to the extent they are logically consistent with each other) to form still other definitions for pre-defined sets of actuation events. For example, the first example and the sixth example may be combined to provide a definition for a pre-defined set of actuation events that specifies that two particular primary vehicle control interfaces be actuated sequentially in-time within a pre-defined time period and with each actuation event exceeding at least a threshold change in magnitude that differs for each actuation event or control interface of the sequence.

Non-limiting examples of pre-defined sets of actuation events are presented below. It will be understood that these examples are merely a few of the many pre-defined sets of actuation events that are supported by the presented disclosure.

### Example 1

A first pre-defined set of actuation events includes discontinuing actuation from an initial actuation state of an accelerator pedal (e.g., removal of foot from the accelerator pedal) and re-actuation of the accelerator pedal two or more times in sequence within a pre-defined time period (e.g., 5 seconds or other suitable period of time).

### Example 2

A second pre-defined set of actuation events includes actuation and discontinuing actuation of the accelerator pedal two or more times in sequence within a pre-defined time period.

### Example 3

A third pre-defined set of actuation events includes discontinuing actuation from an initial actuation state of an brake pedal (e.g., removal of foot from the brake pedal) and re-actuation of the brake pedal two or more times in sequence within a pre-defined time period.

### Example 4

A fourth pre-defined set of actuation events includes actuation and discontinuing actuation of the brake pedal two or more times in sequence within a pre-defined time period. Examples 3 and 4 may be used, for example, to geotag a speed trap setup by law enforcement, for example.

### Example 5

A fifth pre-defined set of actuation events includes turning actuating and discontinuing actuation of the brake or accelerator pedal two or more times in sequence within a pre-defined time period while the vehicle is in a parked state.

### Example 6

A sixth pre-defined set of actuation events includes turning a steering wheel from the right to the left two or more times in sequence within a pre-defined time period while the vehicle is in a parked state.

While the various examples described with reference to method 200 include a sequence of two or more actuation events. In at least some implementations, a pre-defined set of actuation events may include a single actuation event involving a single primary vehicle control interface. Non-limiting examples include:

### Example 7

A seventh pre-defined set of actuation events includes harsh braking (e.g., exceeding a magnitude threshold or a threshold change in magnitude) through a single high-magnitude actuation of the brake pedal. This example may be used, for example, to geotag a hazardous location.

### Example 8

An eighth pre-defined set of actuation events includes pressing the accelerator pedal to the floor or a single high-magnitude actuation (e.g., exceeding a magnitude threshold or a threshold change in magnitude) of the accelerator pedal.

### Example 9

Within the context of automated self-driving vehicles, one or more actuation events initiated by a human operator via one or more primary vehicle control interfaces while the vehicle is operating within a self-driving mode of operation may correspond to a ninth pre-defined set of actuation events. In this implementation, the computing system may detect or otherwise identify the current mode of operation as being in the self-driving mode, thereby enabling any subsequent human operator initiated actuation of a primary vehicle control interface to be identified as a pre-defined set of actuation events.

At 216, the method includes identifying a target geo-location of the vehicle from among the time-based series of geo-locations that is proximate in-time to the pre-defined set of actuation events. As previously described with reference to operation 214, a time value that corresponds to a time that the identified pre-defined set of actuation events was performed by the vehicle operator may be identified by the computing system. This time value may be used to identify and retrieve the target geo-location from the geo-location data that corresponds to that time value. For example, the computing system may search the geo-location data for a geo-location having a corresponding or closest proximate time value based on the time value of the pre-defined of actuation events. As a sub-process to operation 216, a computing device of the computing system may store the target geo-location in a database system from which the target geo-location may be later referenced and/or may transmit the target geo-location to another computing device of the computing system (e.g., either on-board or off-board). In at least some implementations, identifying the target geo-location may be performed responsive to identifying the pre-defined set of actuation events. This implementation may be used, for example, where real-time geotagging is desired of the computing system that is highly responsive the vehicle operator's actions with respect to the primary vehicle control interfaces.

At 218, the method includes associating the target geo-location identified at 216 with a data indicator within a database system. In at least some implementations, this data indicator attributes performance of the pre-defined set of actuation events by the human operator to a geotagging input by the human operator for the target geo-location. The data indicator may include or otherwise indicate a geotag-type. A geotag-type may refer to a human perceivable type of geotag that enables end users to distinguish between or among different geotags as a consequence of their geotag-type. Non-limiting examples of geotag-types include one or more event identifiers, one or more object identifiers, one or more user identifiers, etc. that may be used to convey information to end users. In at least some implementations, the geotag-type may be user-definable in freeform text or with different color or symbol indicators to enable a user to define any suitable geotag-type and the information conveyed by that geotag-type.

As a sub-process of operation 218, the computing system may reference a library of definitions for data indicators (as indicated at 219) that provide an association between a particular data indicator and a particular pre-defined set of actuation events. Each data indicator may include a pre-defined geotag-type that is associated with the pre-defined set of actuation events in the database system. For example, a plurality of data indicators may include or correspond to a plurality of different geotag-types to enable the vehicle operator to initiate geotagging of particular geotag-type by performing the associated pre-defined set of actuation events. Furthermore, in at least some implementations, operation 218 may further include associating a vehicle identifier of the vehicle, a device identifier of an on-board computing device, and/or a human operator identifier of the human operator with the target geo-location and data indicator within the database system. These identifiers are non-limiting examples of source identifiers.

At 220, the method includes outputting an indication of the target geo-location. In at least some implementations, outputting an indication of the target geo-location may include presenting a graphical representation of a map via a display device with a visual indicator present at the target geo-location within the map. Alternatively or additionally, outputting the indication of the target geo-location may include transmitting display data that includes the graphical representation of the map and visual indicator present at the target geo-location within the map to another computing device for presentation. Alternatively or additionally, outputting the indication of the target geo-location may simply include transmitting and/or presenting longitude and latitude coordinates of the target geo-location via a display device or other suitable output device. In some or all of the these examples, a visual indicator may be presented that includes or indicates the pre-defined geotag-type that is associated with the pre-defined set of actuation events in the database system, for example, by way of the definitions previously described at 219.

In at least some implementations the above described geotag-type may be user-defined on a user account basis with respect to the pre-defined set of actuation events with which it is associated. In these implementations, the user may update user-defined information in the user account by logging into the telematics service via a general-purpose browser program or via a special-purpose application program of a client device that is paired with the telematics service, and providing user input through a user account interface of the telematics service. This approach may also be used with regards to defining actuation events. As an example, the telematics service may receive user input data at the computing system that indicates the association between the pre-defined geotag-type and the pre-defined set of actuation events. The telematics service associates the pre-defined geotag-type with the pre-defined set of actuation events in the database system for a target user account indicated by or attributed to the user input data. In the absence of user-defined geotag-types, the geotag-type may correspond to a description of the pre-defined set of actuation events or other suitable information or visual indicator as defined by the telematics service provider.

In at least some implementations, the pre-defined geotag-type may be one of a plurality of pre-defined geotag-types that are available for association with the pre-defined set of actuation events within the database system. Furthermore, the pre-defined set of actuation events may be one of a plurality of pre-defined sets of actuation events that are available for association with the pre-defined geo-tag type within the database system. In the above user-defined implementations, the user input data may include an indication of a user selection of the pre-defined geotag-type from among the plurality of pre-defined geotag-types. Furthermore, the user input data may include an indication of a user selection of the pre-defined set of actuation events from among the plurality of pre-defined sets of actuation events. For example, a first pre-defined set of actuation events may differ from a second pre-defined set of actuation events by one or more of: a quantity of actuation events within a time-based series of actuation events, a time-based parameter of actuation events, a particular vehicle control interface of the primary vehicle control interfaces from which one or more actuation events were obtained.

As a further example of the above implementations, a pre-defined geotag-type may be a first pre-defined geotag-type of a plurality of pre-defined geotag-types, and a pre-defined set of actuation events may be a first pre-defined set of actuation events of a plurality of pre-defined sets of actuation events. This plurality of pre-defined geotag-types may further include a second pre-defined geotag-type that differs from the first pre-defined geotag-type, and the plurality of pre-defined sets of actuation events may include a second pre-defined set of actuation events that differs from the first pre-defined set of actuation events. Within this implementation, the computing system may again implement portions of method 200 for the second set, such as identifying the second pre-defined set of actuation events from among a second time-based series of actuation events in which the second pre-defined set includes two or more pre-defined actuation events performed sequentially in-time by the human operator within the second time-based series of actuation events. Continuing with this example, responsive to or following identifying the second pre-defined set of actuation events, the computing system identifies a second target geo-location of the vehicle from among the time-based series of geo-locations that is proximate in-time to the second pre-defined set of actuation events. The computing system then associates the second target geo-location with a second data indicator including the second pre-defined geotag-type within the database system. Here, the second data indicator attributes performance of the second pre-defined set of actuation events by the human operator to a second geotagging input by the human operator for the second target geo-location.

The various operation of method 200 may be distributed across two or more computing devices (e.g., two or more on-board device, or at least one on-board device and at least one off-board device) in at least some implementations. For example, operation 210 may be performed by a first on-board computing device, while some or all of operations 212, 214, 216, 218, and 220 are performed by another on-board computing device or an off-board computing device. As another example, operations 210 and 212 may be performed by an on-board computing device, while some or all of operations 214, 216, 218, and 220 are performed by an another on-board computing device and/or an off-board computing device. As yet another example, all operations of method 200 may be performed by an individual on-board computing device, or by two on-board computing devices communicating with each other over a wired and/or wireless communications link.

For implementations in which data is transmitted off-board the vehicle to an off-board computing device or computing system, the method performed by the on-board computing device or computing system may include transmitting off-board data to one or more server devices of the computing system over at least a wireless network component of a communications network. This off-board data may include or indicate one or more of the target geo-location, the sensor data, the time-based series of actuation events, and/or a source identifier (e.g., vehicle identifier, on-board device identifier, user account identifier, vehicle operator identifier, etc.) of the off-board data. This off-board data is received at the one or more server devices, and the server devices may then associate the target geo-location with the data indicator within a database system at the one or more server devices. The server devices may then transmit client-bound data to a client device over the communications network for presentation of a graphical representation of a map via the client device with a visual indicator present at the target geo-location within the map, as previously described with reference to operation 220. It will be understood that the client-bound data may include other forms of data output at operation 220, as previously described. In this example, the client device may refer to a client that subscribed to the source identifier of the off-board data transmitted by the on-board computing device.

Some or all of the various operations and sub-processes of method 200 may be performed in real-time in at least some implementations. In an example of a fully-implemented real-time implementation, a geotag may be presented on a user interface of a client device of a user-subscriber moments later or without significant delay following a human operator performing a pre-defined set of actuation events. In other implementations, data maybe stored for later analysis or deployment to end users.

FIG. 3 is a schematic diagram depicting an example graph that provides a visual comparison between time and other parameters relating to vehicle operation. Within FIG. 3, an upper portion of the graph depicts a relationship between magnitude of an operator input provided by a primary vehicle control interface and time. This relationship corresponds to a position of the primary vehicle control interface as it is varied over time by the vehicle operator. As indicated at 310, three actuation events are sequentially performed by the vehicle operator within a threshold time period that exceed both a threshold change in magnitude and an absolute magnitude represented by the upper threshold. Furthermore, a magnitude of each of these three actuation events attains a lower threshold in this example. This lower threshold may correspond to a fully released position of a primary vehicle control interface by the vehicle operator, such as a full pedal release. Alternatively, this lower threshold may correspond to any suitable reference point from which the threshold change is measured. These various aspects of the time-based change in magnitude of a primary vehicle control interface by way of the vehicle operator changing a position of the control interface represent non-limiting examples of the data parameters that may be identified by the computing system within the previously described operations 210 or 214 of method 200. For example, the three actuation events indicated at 310 may be identified by the computing system as being a pre-defined set of actuation events.

Also within FIG. 3, a lower portion of the graph depicts a relationship between latitude and longitude values defining a time-based series of geo-locations for an example moving vehicle within a set of geo-location data. In this example, the geo-location of the vehicle is changing over time. Upon identifying the three actuation events at 310 as corresponding to a pre-defined set of actuation events, a geo-location proximate to the time that the three actuation events were initiated or otherwise performed by the vehicle operator may be identified. Here, for example, a latitude value and a longitude value may be identified by the computing system for the vehicle that corresponds to the time that the pre-defined set of actuation events was initiated or otherwise by the vehicle operator. As previously described with reference to FIG. 3, a time value associated the pre-defined set of actuation events may be identified, in at least some examples, as the time that the first actuation event of the set was initiated by the vehicle operator.

FIG. 4 is a schematic diagram depicting an example system that may serve as an implementation of the system of FIG. 1. Specifically, FIG. 4 is a schematic diagram depicting an example computing system 400. Within computing system 400, a server system 410 hosts a telematics service 412 that receives telematics data from vehicle-based telematics systems. A vehicle-based telematics system may include a vehicle-based telematics device, such as example vehicle-based telematics device 420 and/or an electronic control/monitoring system of a vehicle, such as on-board control system 474 and on-board sensors 476, or a combination of a vehicle-based telematics device and an electronic control and management system of the vehicle. Non-limiting examples of on-board sensors include an accelerometer/inertial sensor, a geo-location sensor subsystem, and the various on-board sensor described herein, among other suitable vehicle-based sensors commonly present on-board commercially available vehicles.

Telematics service 412 may serve an ecosystem of many vehicle-based telematics systems that are located on-board respective vehicles. Telematics service 412 processes data reported by vehicle-based telematics systems and provides processed forms of that reported data and/or analysis results to subscribers. As an example, mobile client device 430 may subscribe to telematics service 412 to receive data reported by vehicle-based telematics device 420. As another example, a third-party service 442 hosted at a third-party server system 440 may subscribe to telematics service 412 to receive data reported by at least some of the vehicle-based telematics devices served by telematics service 412, such as example vehicle-based telematics device 420. Third-party service 442 may in turn provide additional services to clients of the third-party server system.

Within computing system 400, computing devices may communicate with each other via a network 460. Network 460 may include a wide-area network (e.g., such as the Internet or a portion thereof), which includes wired and/or wireless network components. Additionally or alternatively, some computing devices may communicate with each other over personal or local area network components that do not traverse network 460. As an example, mobile client device 430 may communicate with telematics device 420 via a wireless personal area network or a local area network as indicated at 486. As another example, telematics device 420 may communicate with a vehicle 470 via a wired or wireless personal area network or local area network as indicated at 488.

Vehicle 470 includes an OBD interface 472 that enables telematics device 420 to communicate with one or more subsystems of the vehicle, such as on-board control/monitoring system 474 and/or on-board sensors 476, as indicated at 488. As an example, vehicle 470 may provide data 478 to telematics device 420 or receive data 424 from telematics device 420 via OBD interface 472. Vehicle 470 is typically a ride-on road-based vehicle that enables one or more passengers to be transported on-board the vehicle. However, vehicle 470 may take a variety of different forms, including a land-based wheeled, rail, or track vehicle (e.g., car, truck, bus, tractor, train, locomotive, motorcycle, four-wheeler, snowmobile, etc.), an aircraft (e.g., airplane, helicopter, etc.), a marine vessel (e.g., boat or personal watercraft), or other suitable vehicle type.

Telematics device 420 includes a vehicle interface 428 that interfaces with OBD interface 472 of vehicle 470. In wired configurations, vehicle interface 428 may include an electronic connector that mates with a corresponding electronic connector of OBD interface 472 to enable telematics device 420 to send and/or receive communications to and/or from vehicle 470 over a wired communications link. In a wireless configuration, vehicle interface 428 may include a wireless transmitter and/or receiver that enables telematics device 420 to send and/or receive wireless communications to and/or from a wireless receiver and/or transmitter of OBD interface 472. Communications between telematics device 420 and vehicle 470, indicated at 488, may be unidirectional (e.g., from the vehicle to the telematics device) or bidirectional.

Telematics device 420 further includes a telematics program 422 executed by the telematics device, data 424 stored thereon, and optionally one or more integrated sensors 426. Non-limiting examples of integrated sensors include an accelerometer/inertial sensor, a geo-location sensor subsystem, etc. Telematics program 422 receives and/or generates telematics data (e.g., data 424 and/or data 478) representing measurements of real-world vehicle telematics events as measured by on-board sensors 476 of vehicle 470 and/or by integrated sensors 426 (if present). Telematics program 422 provides reports of telematics data to telematics service 412, as indicated by communications path 499. In at least some implementations, a vehicle-based telematics device located on-board a vehicle may not communicate with the vehicle in any way or may have limited communications with the vehicle. In these implementations, measurement data may represent measurements of real-world vehicle telematics events as measured exclusively by integrated sensors of the telematics device.

Telematics device 420, due to its mobility, typically communicates with other computing devices of network 460 over a wireless communications link of a wireless component of network 460, as indicated at 490. In other examples, telematics device 420 may communicate with computing devices of network 460 over a wired communications link, such as periodically via a wired dock or cable during an off-boarding operation. Similarly, mobile client devices (e.g., such as mobile client device 430), due to their mobility, typically communicate with other computing devices of network 460 over a wireless communications link of a wireless component of network 460, as indicated at 492. However, mobile client devices may also use wired communication links to communicate with computing devices of network 460. Server system 410 and third-party server system 440 communicate with other computing devices of network 460 as indicated at 494 and 496, respectively. Each of server systems 410 and 440 may include one or more server devices that are co-located or geographically distributed.

As previously described, data may be provided by telematics service 412 to subscribers, such as mobile client device 430 and/or third-party server system 340, as indicated by data 336 and data 344. Representations of data 336 may be presented to a user of mobile client device 330 via a user interface 334 of client-side application program 332. Program 332 may take the form of a special-purpose program or a general-purpose program by which a user may receive and interact with data or otherwise access services of telematics service 312 and/or third-party services (e.g., 342). User interface 334 may take the form of a graphical user interface in an example. While mobile client device 330 is described in one example as being a subscriber of telematics service 312, mobile client device 330 may alternatively or additionally be a subscriber of third-party service 342.

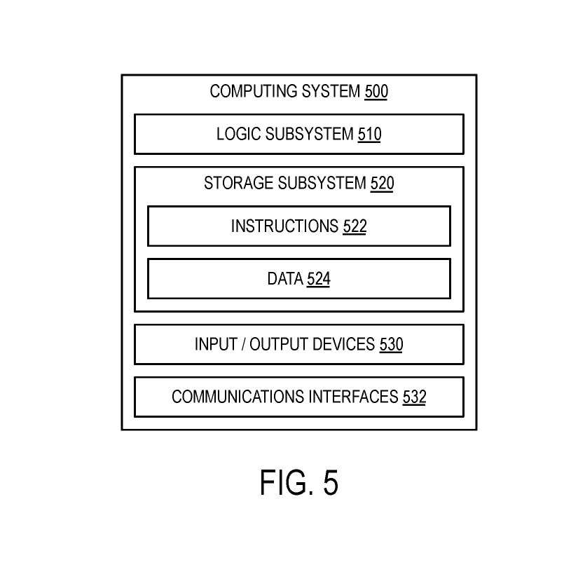

FIG. 5 is a schematic diagram depicting an example computing system 500. Computing system 500 is a non-limiting example of the various computing systems described herein, including on-board computing systems, off-board computing systems, or combinations of on-board and off-board computing devices that collectively form a computing system.

Computing system 500 may be configured (e.g., via instructions) to implement and perform the methods, processes, operations, functions, or techniques described herein. FIG. 5 depicts computing system 500 in simplified form. A computing system or a computing device thereof may take a variety of different forms including a personal computer, a server computer, a wireless device, a personal electronic device, a vehicle-based telematics device, a vehicle-based telematics system, and/or other electronic devices that incorporate computer hardware and software.

A logic subsystem, such as example logic subsystem 510, may include one or more physical logic devices or machines configured to execute instructions stored or otherwise held in a storage subsystem, such as example storage subsystem 520. For example, a logic subsystem may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

A logic subsystem may include one or more processor devices (i.e., processors) (as an example of physical logic devices) configured to execute software instructions, such as example instructions 522. Additionally or alternatively, the logic subsystem may include one or more logic machines (as an example of physical logic devices) configured to execute hardcoded instructions. Processors of the logic subsystem may be single-core or multi-core. Instructions executed by the logic subsystem may be configured for sequential, parallel, and/or distributed processing. Individual components of the logic subsystem may be distributed among two or more separate devices, which may be remotely located and/or configured for coordinated processing. Aspects of the logic subsystem may be virtualized and executed by remotely accessible, networked computing devices configured in a cloud-computing configuration.

A storage subsystem includes one or more physical memory devices or machines configured to hold instructions (e.g., 522) or other forms of data (e.g., 524). These one or more physical memory devices may take the form of non-transitory memory devices configured to hold instructions or other forms of data in non-transitory form. As previously discussed, instructions are executable by a logic subsystem, to implement or otherwise perform the methods, processes, operations, functions, and techniques described herein. While instructions may be held in non-transitory form, such non-transitory instructions may be updated from time to time to add, remove, or modify the methods, processes, operations, functions, or techniques implemented or performed by the computing device upon execution of the instructions. While a storage subsystem includes one or more physical devices, aspects of the instructions and/or other forms of data described herein may, at times, be propagated by a communication medium (e.g., an electromagnetic signal, an optical signal, etc.) that is not necessarily held by a physical device for a finite duration.

Aspects of a logic subsystem and a storage subsystem may be integrated together into one or more hardware-logic components. Such hardware-logic components may include field-programmable gate arrays (FPGAs), program-specific and application-specific integrated circuits (PASIC/ASICs), program-specific and application-specific standard products (PSSP/ASSPs), system-on-a-chip (SOC), and complex programmable logic devices (CPLDs), as non-limiting examples.

One or more physical memory devices of a storage subsystem may be configured to hold other forms of data in a data store or data storage. When the methods, processes, operations, functions, or techniques described herein are implemented or otherwise performed, the state of the storage subsystem may be transformed (e.g., to hold different data). A storage subsystem may include removable and/or built-in devices. A storage subsystem may include optical memory devices, semiconductor memory devices, and/or magnetic memory devices, among other suitable forms. A storage subsystem may include volatile, nonvolatile, dynamic, static, read/write, read-only, random-access, sequential-access, location-addressable, file-addressable, and/or content-addressable devices.

Terms such as “module” or “program,” may be used to describe an aspect of a computing system implemented to perform a particular function. In some cases, a module or program may be instantiated via a logic subsystem executing instructions held by a storage subsystem. It will be understood that different modules and/or programs may be instantiated from the same application, service, code block, object, library, routine, API, function, etc. Likewise, the same module and/or program may be instantiated by different applications, services, code blocks, objects, routines, APIs, functions, etc. The terms module and program may encompass individual or groups of executable files, data files, libraries, drivers, scripts, database records, etc. The term service may be used refer to an application program, module, or other instruction set executable across multiple sessions (e.g., of a user account or a telematics device). A service may be available to one or more system components, programs, and/or other services. In some implementations, a service may run on one or more server devices of a server system.

Computing system 500 may further include or interface with one or more input and/or output devices 530. Non-limiting examples of input devices include the primary vehicle control interfaces described herein, a sensor, a touch-sensitive graphical display device, a keyboard, a computer mouse, a microphone, an optical sensor, an accelerometer/inertial sensor, etc. Non-limiting examples of output devices include a graphical display device, an audio speaker, a haptic feedback device, etc.

Computing system 500 may further include one or more communications interfaces 532. Non-limiting examples of communications interfaces include wired and/or wireless communications interfaces that support wired and/or wireless communications over wide area networks, local area networks, or personal area networks using any suitable communications protocol, including OBD protocols, cellular protocols, WLAN protocols, Internet protocols, etc. Such communications interfaces further include GNSS receiver/transmitter interface components, as previously described with reference to a geo-location sensor subsystem.

It will be understood that the configurations and/or approaches described herein are exemplary in nature, and that these specific examples or implementations are not to be considered in a limiting sense, because numerous variations are possible. The specific methods described herein may represent one or more of any number of processing strategies. As such, various acts illustrated and/or described may be performed in the sequence illustrated and/or described, in other sequences, in parallel, or omitted. Likewise, the order of the above-described methods may at times be changed. The subject matter of the present disclosure includes all novel and nonobvious combinations and sub-combinations of the various configurations, approaches, systems, methods, processes, operations, functions, techniques, and other features or properties disclosed herein, as well as any and all equivalents thereof.

1. A geotagging method performed by a computing system that includes at least one computing device residing on-board a human-operable vehicle, the method comprising:
receiving, at the computing device of the computing system, sensor data indicating a time-based series of actuation events performed by a human operator of the vehicle and obtained via one or more primary vehicle control interfaces of the vehicle, the primary vehicle control interfaces including at least a steering control interface, an accelerator control interface, and a brake control interface;
receiving geo-location data indicating a time-based series of geo-locations of the vehicle obtained via a geo-location sensor subsystem of the computing system;
identifying a pre-defined set of actuation events from among the time-based series of actuation events, the pre-defined set including two or more pre-defined actuation events performed sequentially in-time by the human operator within the time-based series of actuation events;
identifying a target geo-location of the vehicle from among the time-based series of geo-locations that is proximate in-time to the pre-defined set of actuation events; and
associating the target geo-location with a data indicator within a database system, the data indicator attributing performance of the pre-defined set of actuation events by the human operator to a geotagging input by the human operator for the target geo-location.

2. The method of claim 1, wherein the data indicator includes a pre-defined geotag-type that is associated with the pre-defined set of actuation events in the database system.

3. The method of claim 2, wherein the pre-defined geotag-type is user-defined on a user account basis with respect to the pre-defined set of actuation events.

4. The method of claim 3, further comprising:
receiving user input data at the computing system, the user input data indicating the association between the pre-defined geotag-type and the pre-defined set of actuation events; and
associating the pre-defined geotag-type with the pre-defined set of actuation events in the database system for a target user account indicated by or attributed to the user input data.

5. The method of claim 4, wherein the pre-defined geotag-type is one of a plurality of pre-defined geotag-types that are available for association with the pre-defined set of actuation events within the database system; and
wherein the user input data includes an indication of a user selection of the pre-defined geotag-type from among the plurality of pre-defined geotag-types.

6. The method of claim 4, wherein the pre-defined set of actuation events is one of a plurality of pre-defined sets of actuation events that are available for association with the pre-defined geo-tag type within the database system; and
wherein the user input data includes an indication of a user selection of the pre-defined set of actuation events from among the plurality of pre-defined sets of actuation events.

7. The method of claim 2, wherein the pre-defined geotag-type is a first pre-defined geotag-type of a plurality of pre-defined geotag-types, and the pre-defined set of actuation events is a first pre-defined set of actuation events of a plurality of pre-defined sets of actuation events; and
wherein the plurality of pre-defined geotag-types further includes a second pre-defined geotag-type that differs from the first pre-defined geotag-type, and the plurality of pre-defined sets of actuation events includes a second pre-defined set of actuation events that differs from the first pre-defined set of actuation events.

8. The method of claim 7, wherein the method further comprises:
identifying the second pre-defined set of actuation events from among a second time-based series of actuation events, the second pre-defined set including two or more pre-defined actuation events performed sequentially in-time by the human operator within the second time-based series of actuation events;
responsive to identifying the second pre-defined set of actuation events, identifying a second target geo-location of the vehicle from among the time-based series of geo-locations that is proximate in-time to the second pre-defined set of actuation events; and
associating the second target geo-location with a second data indicator including the second pre-defined geotag-type within the database system, the second data indicator attributing performance of the second pre-defined set of actuation events by the human operator to a second geotagging input by the human operator for the second target geo-location.

9. The method of claim 7, wherein the first pre-defined set of actuation events differs from the second pre-defined set of actuation events by one or more of: a quantity of actuation events within the time-based series of actuation events, a time-based parameter of actuation events, a particular vehicle control interface of the primary vehicle control interfaces from which one or more actuation events were obtained.

10. The method of claim 2, further comprising:
presenting a graphical representation of a map via a display device with a visual indicator present at the target geo-location within the map, the visual indicator including or indicating the pre-defined geotag-type.

11. The method of claim 1, further comprising:
associating a vehicle identifier of the human-operable vehicle and/or a human operator identifier of the human operator with the target geo-location and data indicator within the database system.

12. The method of claim 1, wherein receiving the geo-location data, identifying the pre-defined set of actuation events, identifying the target geo-location, and associating the target geo-location with the data indicator is performed by the computing device residing on-board the vehicle in real-time; and
wherein the method further comprises:
presenting a graphical representation of a map via a display device residing on-board the vehicle with a visual indicator present at the target geo-location within the map.

13. The method of claim 1, wherein receiving the geo-location data, identifying the pre-defined set of actuation events, and identifying the target geo-location is performed by the computing device residing on-board the vehicle in real-time; and
wherein the method further comprises:
transmitting off-board data to one or more server devices of the computing system over at least a wireless network component of a communications network, the off-board data indicating the target geo-location and a source identifier of the off-board data;
receiving the off-board data at the one or more server devices;
associating the target geo-location with the data indicator within the database system at the one or more server devices; and
transmitting client-bound data to a client device over the communications network for presentation of a graphical representation of a map via the client device with a visual indicator present at the target geo-location within the map, the client device being subscribed to the source identifier.

14. The method of claim 1, wherein receiving the geo-location data, identifying the pre-defined set of actuation events, identifying the target geo-location, and associating the target geo-location with the data indicator is performed by one or more server devices of the computing system located remotely from the vehicle; and
wherein the method further comprises:
transmitting off-board data to the one or more server devices over at least a wireless network component of a communications network, the off-board data including the sensor data or indicating the time-based series of actuation events.

15. The method of claim 1, wherein each actuation event of the pre-defined set of actuation events exceeds at least a threshold change in magnitude for each actuation event, and each actuation event of the pre-defined set of actuation events is performed sequentially in-time within a pre-defined time period.

16. The method of claim 1, wherein each actuation event of the pre-defined set of actuation events includes a dynamic change in a direction and/or a magnitude for each actuation event from a reference point, and each actuation event of the pre-defined set of actuation events is performed sequentially in-time within a pre-defined time period.

17. The method of claim 1, wherein each actuation event of the pre-defined set of actuation events includes a release and re-engagement of a primary vehicle control interface for each actuation event, and each actuation event of the pre-defined set of actuation events is performed sequentially in-time within a pre-defined time period.

18. The method of claim 1, wherein each actuation event of the pre-defined set of actuation events includes, for a particular primary vehicle control interface, at least two actuation events performed sequentially in-time within a pre-defined time period via that primary vehicle control interface; or wherein the pre-defined set of actuation events includes at least three actuation events performed sequentially in-time within a pre-defined time period.

19. The method of claim 1, wherein the computing device residing on-board the vehicle interfaces with an electronic control/monitoring system of the vehicle via an OBD-compliant data link.

20. A computing system, including at least one computing device residing on-board a human operable vehicle, the computing system comprising:
a logic subsystem; and
a storage subsystem having instructions stored thereon executable by the logic subsystem to:
receive, at the computing device of the computing system, sensor data indicating a time-based series of actuation events performed by a human operator of the vehicle and obtained via one or more primary vehicle control interfaces of the vehicle, the primary vehicle control interfaces including at least a steering control interface, an accelerator control interface, and a brake control interface;
receive geo-location data indicating a time-based series of geo-locations of the vehicle obtained via a geo-location sensor subsystem of the computing system;
identify a pre-defined set of actuation events from among the time-based series of actuation events, the pre-defined set including two or more pre-defined actuation events performed sequentially in-time by the human operator within the time-based series of actuation events;
identify a target geo-location of the vehicle from among the time-based series of geo-locations that is proximate in-time to the pre-defined set of actuation events; and
associate the target geo-location with a data indicator within a database system, the data indicator attributing performance of the pre-defined set of actuation events by the human operator to a geotagging input by the human operator for the target geo-location.
